(19) United States
(12) Patent Application Publication
(10) Pub. No.: US 2023/0347557 A1
(43) Pub. Date: Nov. 2, 2023

(54) POLYMERIC SHELLS AND PARTICLES FOR VACUUM INSULATION PANELS

(71) Applicant: UT-Battelle, LLC, Oak Ridge, TN (US)

(72) Inventors: Diana Hun, Oak Ridge, TN (US); Tomonori Saito, Oak Ridge, TN (US); James W. Klett, Oak Ridge, TN (US); Tristan M. Alexander, Oak Ridge, TN (US); Som S. Shrestha, Oak Ridge, TN (US); Ryan K. Duncan, Oak Ridge, TN (US); Kaushik Biswas, Oak Ridge, TN (US); Bingrui Li, Oak Ridge, TN (US)

(21) Appl. No.: 18/211,784

(22) Filed: Jun. 20, 2023

Related U.S. Application Data
(63) Continuation of application No. 17/105,727, filed on Nov. 27, 2020.
(60) Provisional application No. 63/066,835, filed on Aug. 18, 2020.
(60) Provisional application No. 62/940,507, filed on Nov. 26, 2019.

(51) Int. Cl. B29C 44/50; C08K 3/04; B29C 44/02; C08K 3/34; C08J 9/228

(52) U.S. Cl. CPC B29C 44/505; B29C 44/02; C08J 9/228; C08K 3/04; C08K 3/346; B29K 2101/12; C08J 2329/02

(57) ABSTRACT

A method of forming a polymeric vacuum insulation board is provided, the polymeric vacuum insulation board including a plurality of evacuated, closed-cell pores therein. In one embodiment, the method includes intermixing a polymer with zeolite particles that contain water and extruding the resulting composition under high pressure. During extrusion, water in the zeolite particles evaporates and creates a porous, closed-cell microstructure within a polymer matrix. As the polymer matrix cools and solidifies, water vapor is reabsorbed by the zeolite, which at least partially evacuates the closed-cell pores. In another embodiment, the method includes intermixing a polymer with expandable graphite particles and extruding the resulting composition under high pressure. During extrusion, the expandable graphite particles define evacuated voids. The polymer binder can be selected to include low gas permeance, for example ethylene vinyl alcohol (EvOH) or polyvinylidene chloride (PVDC). In some applications, the polymer can be blended with nano-clays or other additives to further decrease the gas permeance of the vacuum insulation board.

### CROSS REFERENCE TO RELATED APPLICATIONS

This application is a divisional of U.S. Application No. 17/105,727, filed Nov. 27, 2020, which claims the benefit of U.S. Provisional Application No. 62/940,507, filed Nov. 26, 2019, and U.S. Provisional Application 63/066,835, filed on Aug. 18, 2020, the disclosures of which are incorporated by reference in their entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to polymeric boards for use as vacuum insulation panels and methods for manufacturing the same.

### BACKGROUND OF THE INVENTION

Traditional vacuum insulation panels include a gas-tight enclosure and a rigid core from which air and water vapor has been evacuated. Vacuum insulation panels are used for building insulation materials and insulating refrigerators and freezers, and provide extremely low thermal conductivity, particularly when compared to fibrous insulation materials, such as fiberglass, and polymer foams, such as foamed polystyrene. Vacuum insulation panels are also employed in shipping containers and refrigerated cargo areas of trains, trucks, and aircraft.

Vacuum insulation panels can achieve a thermal performance of about R40 per inch (i.e., 40 h·ft²·°F·Btu/in) due to the vacuum in their open cell, nanoporous core that reduces gas/air conduction and that decreases gas/air convection, and due to opacifiers that limit radiation within the nanostructure. Although efforts are ongoing to decrease the price of vacuum insulation panels, vacuum insulation panels are fragile because the air/vapor barrier film that maintains the vacuum can be easily punctured, which cuts the thermal performance of a 2 feet by 2 feet panel by a factor of about 5. Moreover, the size of the vacuum insulation panels cannot be adjusted at the construction site because the panels cannot be cut to size. Thus, materials with a lower R-value need to be used as infills, which lowers the effective R-value of the system and slows installation. Lastly, current US manufacturing practices limit maximum vacuum insulation panel sizes to about 2 feet by 4 feet, which leads to a large number of panel joints that lower their effective R-value.

Accordingly, there remains a continued need for a method of manufacturing an improved vacuum insulation panel, and in particular, a closed-cell vacuum insulation board.

### SUMMARY OF THE INVENTION

A method of forming a polymeric vacuum insulation board is provided, the polymeric vacuum insulation board including a plurality of evacuated, closed-cell voids or cells therein. In one embodiment, the method includes intermixing a polymer with zeolite particles that contain water and extruding the resulting composition under high pressure. During extrusion, water in the zeolite particles evaporates due to reduced pressure right after passing a spinneret and creates a porous, closed-cell microstructure within a polymer matrix. As the polymer matrix cools and solidifies, water vapor is reabsorbed by the zeolite, which at least partially evacuates the closed-cell pores. The polymer can be selected to include low gas permeance, for example poly(ethylene-co-vinyl alcohol) (EvOH), polyvinylidene chloride (PVDC), polymethyl methacrylate (PMMA), poly(acrylonitrile) (PAN) and copolymers such as poly(acrylonitrile-co-butadiene-co-styrene) (ABS), or combinations thereof. In some applications, the polymer can be blended with nano-clays or other additives to further decrease the gas permeance of the vacuum insulation board.

In another embodiment, the pores within the polymer matrix are formed using expandable graphite particles. In particular, the method includes intermixing a polymer with graphite particles having a first diameter at a first temperature. The method further includes exposing the resulting composition to an elevated temperature during and/or after extrusion into a board. The graphite particles expand to a second diameter greater than the first diameter. During expansion, voids are developed within the graphite particles that in turn lead to evacuated closed cells within the polymer.

In these and other embodiments, the polymer matrix can be blended with additives. To mix the polymer matrix with the additives, polymer feedstock is added to a rotating tumbler, the feedstock is sprayed with a 1-10% aqueous solution of polyvinylpyrrolidone (PVP), and additives are slowly added to the tumbler to coat the feedstock. Suitable polymers include EvOH, PVDC, and PMMA, PAN, ABS. Nanoclay, such as bentonite (e.g., CLOISITE-Na+ and CLOISITE-116), is an additive that, at 5-30 wt%, reduces the thermal conductivity and gas permeability of the polymer.

The present method can include forming a polymeric vacuum insulation board using typical foam manufacturing processes, as well as other techniques, including additive manufacturing techniques. In these and other embodiments, the resulting polymeric vacuum insulation board can exhibit an improved R-value per inch while being substantially less susceptible to punctures and easier to install. Additionally, the polymeric vacuum insulation board may simultaneously function as the heat, air, and moisture barrier, which will decrease the number of installed materials, assembly time, and labor cost.

These and other features and advantages of the present invention will become apparent from the following description of the invention, when viewed in accordance with the accompanying drawings and appended claims.

### BRIEF DESCRIPTION OF THE DRAWINGS

FIG. 1 is a cut-away view of a closed-cell, polymeric vacuum insulation board including zeolite particles and a plurality of voids in accordance with a first embodiment.

FIG. 2 is a cut-away view of a closed-cell, polymeric vacuum insulation board including expanded graphite particles in accordance with a second embodiment.

FIG. 3 is a perspective cut-away view of a closed-cell, polymeric vacuum insulation sphere including a particle and defining a void in accordance with a third embodiment.

FIG. 4 is a perspective cut-away view of a closed-cell, polymeric vacuum insulation board including a shell in accordance with a fourth embodiment.

### DETAILED DESCRIPTION OF THE CURRENT EMBODIMENTS

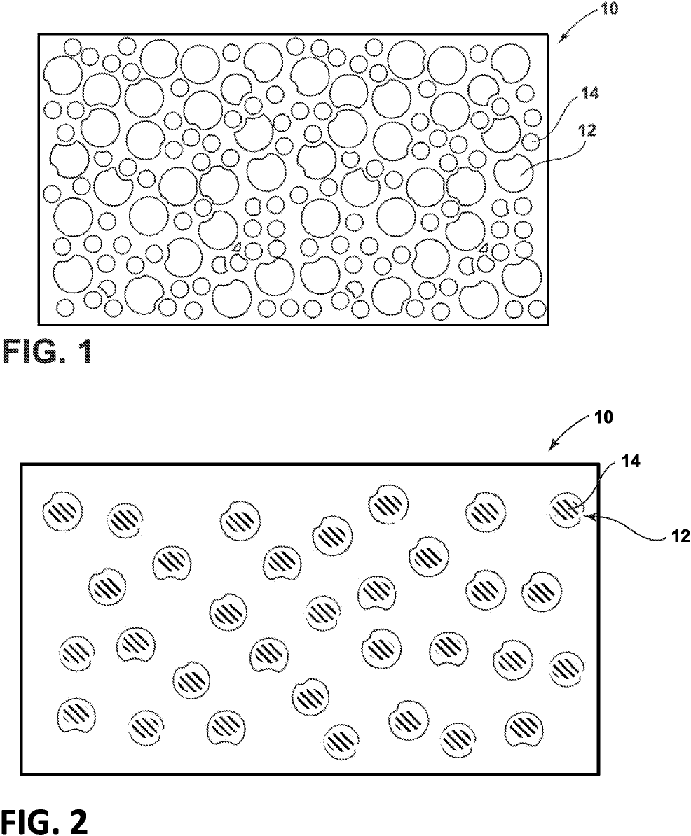

With reference to FIG. 1, a closed-cell, polymeric vacuum insulation board in accordance with a first embodiment is illustrated and designated 10. The vacuum insulation board 10 is formed from a vacuum insulation material. The vacuum insulation board 10 may be a closed cell foam and may have an R-value of at least 10 per inch, for example about 14 per inch.

The vacuum insulation material comprises a polymer matrix. The polymer matrix comprises EvOH, PVDC, PMMA, PAN, ABS, or combinations thereof. In certain embodiments, the polymer matrix originates as a pelletized feedstock. However, it is to be appreciated that the feedstock may have any shape. The pelletized feedstock may comprise polyvinylpyrrolidone (PVP) disposed on the surface. The vacuum insulation material further comprise particles 12 having a porous structure. In the embodiment of FIG. 1, the particle comprises a zeolite. Non-limiting examples of suitable zeolites include zeolites 3A, zeolite Y74, or a combination thereof. In these and other embodiments, the pore comprises a fluid (e.g., a gas or a liquid). Non-limiting examples of a suitable fluid include water, carbon dioxide, propanol, and combinations thereof. In the embodiment of FIG. 2, the particles 12 comprise expandable graphite, for example expandable graphite commercially available from Asbury Carbons.

The vacuum insulation material further defines a void 14 therein. In the embodiment of FIG. 1, the void 14 is formed from expansion of the fluid (e.g., via evaporation of the fluid). In the embodiment of FIG. 2, the void 14 is defined within the graphite particles resulting from expansion of the graphite particle. As used herein, a “void” means a cell or open region in the polymer matrix or in the particle that is formed by expansion of a fluid and/or by expansion of a particle. In the case of zeolite, the void includes a cell that is formed by expansion of a fluid, for example the vaporization of water contained within the zeolite particle, and its subsequent reabsorption into the zeolite particle. In the case of graphite, the void includes pores created in the graphite particle due to its expansion.

The vacuum insulation material may further comprise a nanoclay. The nanoclay may comprise bentonite. Non-limiting examples of suitable nanoclays include a bentonite commercially available from BYK under the trade name CLOISITE-Na+ and CLOISITE 116. The vacuum insulation material may include the nanoclay in an amount of from at least 5 wt.% for reducing the thermal conductivity and gas permeability of the polymer matrix.

A method of forming the vacuum insulation board 10 of FIG. 1 is provided. The method comprises providing particles 12, for example zeolite particles containing a fluid. The method further comprises combining the polymer matrix and the particles 12 to form the vacuum insulation material at a first temperature. The first temperature may be from about 0° C. to about 100° C., optionally from about 10° C. to about 50° C., or optionally from about 15° C. to about 25° C. The method further comprises exposing the vacuum insulation material to a second temperature greater than the first temperature to form the void 14 within the vacuum insulation material. The second temperature may be from about 80° C. to about 300° C., optionally from about 150° C. to about 250° C., or optionally from about 175° C. to about 225° C. The step of exposing the vacuum insulation material to the second temperature may comprise the step of extruding the vacuum insulation material at the second temperature greater than the first temperature to form voids 14 within the vacuum insulation material. The method further comprises exposing the vacuum insulation material to a third temperature less than the second temperature to form the vacuum insulation board 10. The third temperature may be from about 0° C. to about 100° C., optionally from about 10° C. to about 50° C., or optionally from about 15° C. to about 25° C. The fluid within the particles 12 may be in a liquid state at the first temperature and the third temperature, and may be in a gas state at the second temperature, optionally in combination with a decrease in pressure. It is to be appreciated that as the fluid transitions from a gas state to a liquid state due to exposure to the third temperature, the voids 14 become evacuated thereby forming a vacuum therein. Further, the fluid in the liquid state may be reabsorbed by the particles 12 thereby further evacuating the voids 14 to further form the vacuum therein. The term “vacuum” as utilized herein with regard to the zeolite particle 12 means that the void 14 has a pressure of less than 1 atm, optionally less than 0.1 atm, optionally less than 0.01 atm, optionally less than 0.001 atm, or optionally less than 0.0001 atm. Alternatively, the term “vacuum” as utilized herein with regard to the zeolite particle 12 means that the void 14 is substantially devoid of matter.

A method of forming the vacuum insulation board 10 of FIG. 2 is provided. The method comprises providing an expandable graphite particle 12 having a first diameter at a first temperature. The first diameter may be in an amount of less than 200 micrometers, optionally less than 100 micrometers, or optionally less than 75 micrometers. The first temperature may be from about 0° C. to about 150° C., optionally from about 20° C. to about 150° C., or optionally from about 120° C. to about 150° C. The method further comprises combining the polymer matrix and the graphite particle 12 to form the vacuum insulation material. The method further comprises exposing the vacuum insulation material to a second temperature greater than the first temperature, the graphite particle 12 having a second diameter greater than the first diameter at the second temperature to form the void 14 within the graphite particle 12. The second diameter of the graphite particle 12 may be in an amount of from 225 to about 600, optionally about from 250 to about 500, or optionally about from 295 to about 425. The second temperature may be from about 160° C. to about 500° C., optionally from about 180° C. to about 300° C., or optionally from about 190° C. to about 220° C. The step of exposing the vacuum insulation material to the second temperature may comprise the step of extruding the vacuum insulation material at the second temperature greater than the first temperature to form the void 14 within the graphite particle 12. It is to be appreciated that as the graphite particles 12 expand due to exposure to the second temperature, the resulting voids 14 in the exterior of the graphite particles 12 remain evacuated, thereby forming a vacuum therein. The term “vacuum” as utilized herein with regard to the void 14 resulting from the graphite particles 12 means that the void 14 has a pressure of less than 1 atm, optionally less than 0.1 atm, optionally less than 0.01 atm, optionally less than 0.001 atm, or optionally less than 0.0001 atm. Alternatively, the term “vacuum” as utilized herein with regard to the void 14 resulting from the graphite particles 12 means that the void 14 is substantially devoid of matter. In various embodiments, the vacuum insulation material is adapted to form a closed cell foam to maintain the vacuum within the voids 14. The method further comprises exposing the vacuum insulation material to a third temperature less than the second temperature to form the vacuum insulation board 10. The third temperature may be from about 0° C. to about 150° C., optionally from about 10° C. to about 80° C., or optionally from about 20° C. to about 30° C.

In one laboratory example, EvOH and expandable graphite 3538 were mixed at a 10:1 weight ratio, and the resulting composition was fed into a Filabot X-2 extruder at 190° C., and a dense polymer disk was obtained. The polymer disk was transferred into a 210° C. preheated vacuum oven. The polymer disk was kept under vacuum for 3 hours, and then the heating source was removed. After 6 hours, the vacuum oven cooled down, and the disk-shaped vacuum insulation material was obtained.

In an exemplary embodiment, a method of forming the vacuum insulation board 10 comprises the step of extruding the polymer matrix that is blended with additives. Some of the additives may be intended to reduce the thermal conductivity and gas permeability of the polymer matrix. Other additives are blowing agents (e.g., zeolites) that contain water and may have the dual purpose of generating voids 14 in the extruded vacuum insulation material and creating vacuum in the voids 14. More specifically, during the extrusion process, the polymer matrix encapsulates the particles 12 and the pressure created by the extrusion process maintains the water inside the particles 12 even after the polymer matrix has melted. When the polymer matrix and the particles 12 exit the extrusion nozzle, pressure on the porous support 12 may drop nearly instantaneously leading to the water inside the porous supports 12 to flash out as steam thereby creating voids 14 within the vacuum insulation material. Afterwards, the water will be adsorbed by the porous supports 12, which creates a vacuum in the voids 14.

In one embodiment, a method of forming the vacuum insulation board 10 comprises the step of extruding the polymer matrix that is blended with additives such as expandable graphite. The extruded material with expandable graphite can create vacuum in the voids 14 in situ and/or with an additional post process such as foam formation process at elevated temperature under reduced pressure creates vacuum insulation board. In another embodiment, the vacuum insulation material is extruded using multiple parallel nozzles to form the vacuum insulation board 10 (e.g., 4 foot by 8 foot board). In another embodiment, the vacuum insulation material is printed using a large-scale 3D printer such as the Big Area Additive Manufacturing printer to form the vacuum insulation board 10. It is to be appreciated that any process or apparatus suitable for forming closed cell foams may be utilized to form the vacuum insulation board 10 from the vacuum insulation material.

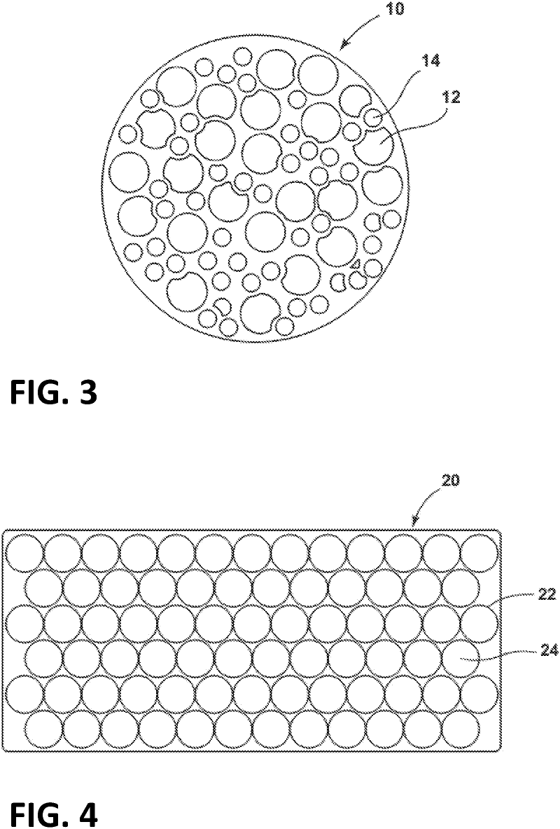

With specific reference to FIG. 3, in an alternative embodiment, the vacuum insulation material may be formed into a vacuum insulation sphere. In one embodiment, hot air blowing at the end of an extrusion needle is utilized to pull the vacuum insulation material at a speed that is faster than the extrusion rate, which separates the vacuum insulation material into spheres before the polymer matrix solidifies. In another embodiment, the vacuum insulation material is processed through a mechanical chopper to form spheres before the polymer matrix solidifies. The spheres may be assembled into vacuum insulation board 10 using a binder such as polyisocyanate foam.

With reference to FIG. 4, a vacuum insulation panel in accordance with another embodiment is illustrated and designated 20. The vacuum insulation board 20 comprises a shell 22. In various embodiments, the vacuum insulation board 20 comprises a plurality of shells 22 disposed throughout the vacuum insulation board 20. The shell 22 may comprise, consist essentially of, consist of, or be formed from polynorbornene or derivatives thereof. In various embodiments, the shell 22 is further defined as a microsphere. The shell 22 defines a void 24 that is under a vacuum. The term “vacuum” as utilized herein means that the void 24 has a pressure of less than 1 atm, optionally less than 0.1 atm, or optionally less than 0.01 atm. Alternatively, the term “vacuum” as utilized herein means that the void 24 is substantially devoid of matter. The vacuum insulating board 20 may have an R-value of at least 30 per inch, for example about 35 per inch.

A method of forming a vacuum insulation shell 22 is provided herein. The method comprises providing a shell 22. The shell defines the void 24 comprising a hydrocarbon at a first temperature. Non-limiting examples of suitable hydrocarbons, include pentane, or combinations thereof. The first temperature may be from about 0° C. to about 40° C., optionally from about 10° C. to about 30° C., or optionally from about 15° C. to about 25° C. The method may further comprise exposing the shell 22 to a second temperature greater than the first temperature to form the vacuum insulation shell 22. The hydrocarbon is in a liquid state at the first temperature and is in a gas state at the second temperature. The second temperature may be from about 40° C. to about 300° C., optionally from about 40° C. to about 200° C., or optionally from about 40° C. to about 100° C. In various embodiments, the second temperature is at least 10° C. greater than the first temperature. The shell 22 may be adapted to allow permeation of a hydrocarbon across the shell 22 and adapted to minimize permeation of air across the shell 22. The term “air” as utilized herein means a gas including nitrogen, oxygen, carbon dioxide, or combinations thereof. In certain embodiments, the step of providing the shell 22 comprising polynorbornene, comprises the step of encapsulating the hydrocarbon in the void 24 of the shell 22 at the first temperature. The step of encapsulating the hydrocarbon in the void 24 may comprise the step of providing the shell 22 comprising polynorbornene. The step of encapsulating the hydrocarbon in the void 24 may further comprise the step of disposing the hydrocarbon in the void 24 of the shell 22 at the first temperature.

A method of forming the vacuum insulation board 20 is also provided herein. The method comprises providing the shell 22. The method further comprises combining a polymer matrix and the shell 22 to form the vacuum insulation board 20. In certain embodiments, the step of combining the binder and the vacuum insulation shell 22, comprises the step of combining a binder and the vacuum insulation shell 22 to form a vacuum insulation material. The step of combining the polymer matrix and the vacuum insulation shell 22, may further comprise applying the vacuum insulation material to a substrate to form the vacuum insulation board 20. The substrate may include a mold to form panels (e.g., 4 foot by 8 foot board), a wall cavity, or any other surface or cavity suitable to receive a spray-applied membrane or foam. In various embodiments, the step of applying the vacuum insulation material comprises the step of extruding the vacuum insulation material at the second temperature greater than the first temperature to evacuate the shell 22 of the hydrocarbon. The vacuum insulation material may be extruded using any process or apparatus known in the art for forming the vacuum insulation board 20. In certain embodiments, the vacuum insulation material is extruded using multiple parallel nozzles or a large-scale 3D printer such as the Big Area Additive Manufacturing printer to form the vacuum insulation board 10 (e.g., 4 foot by 8 foot board). In other embodiments, the step of applying the vacuum insulation material comprises the step of spraying the vacuum insulation material on the substrate to form the vacuum insulation board 20.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A method of forming a vacuum insulation board, the method comprising:
providing a composition including a polymer matrix having a plurality of expandable graphite particles dispersed therein;
forming the composition into a vacuum insulation board; and
heating the vacuum insulation board to cause the plurality of expandable graphite particles dispersed therein to expand, such that the graphite particles include a plurality of evacuated voids.

2. The method of claim 1, wherein providing a composition includes intermixing a polymer with the plurality of expandable graphite particles.

3. The method of claim 2, wherein the polymer includes ethylene vinyl alcohol, polyvinylidene chloride, polymethyl methacrylate, poly(acrylonitrile), and poly(acrylonitrile-co-butadiene-co-styrene), or combinations thereof.

4. The method of claim 1, wherein providing a composition further includes intermixing the polymer with a nano-clay additive.

5. The method of claim 4, wherein the nano-clay additive comprises bentonite.

6. A vacuum insulation board comprising:
a polymer matrix; and
a plurality graphite particles dispersed within the polymer matrix, plurality graphite particles including a plurality of evacuated voids.

7. The vacuum insulation board of claim 6, wherein the polymer matrix includes ethylene vinyl alcohol, polyvinylidene chloride, polymethyl methacrylate, poly(acrylonitrile) (PAN), and poly(acrylonitrile-co-butadiene-co-styrene) (ABS).

8. The vacuum insulation board of claim 6, further including a nano-clay additive.

9. The vacuum insulation board of claim 8, wherein the nano-clay additive comprises bentonite.

10. The vacuum insulation board of claim 8, wherein the polymer matrix includes a uniform dispersion of the plurality of the plurality graphite particles therein.
